(19) United States
(12) Patent Application Publication
(10) Pub. No.: US 2014/0238974 A1
(43) Pub. Date: Aug. 28, 2014

(54) Process for Producing a Resistance Heating Element and Also Resistance Heating Element

(71) Applicants: Gotthard Nauditt, Huttenberg (DE); Roland Weiss, Huttenberg (DE); Jeremias Schonfeld, Friedberg (DE)

(72) Inventors: Gotthard Nauditt, Huttenberg (DE); Roland Weiss, Huttenberg (DE); Jeremias Schonfeld, Friedberg (DE)

(21) Appl. No.: 14/009,268

(22) PCT Filed: Mar. 28, 2012
(86) PCT No.: PCT/EP2012/055462

§ 371 Date: May 8, 2014

(30) Foreign Application Priority Data
Apr. 6, 2011 (DE) 10 2011 006 850.3

(51) Int. Cl. H05B 3/48; H05B 3/14; H01C 17/30; H01C 17/02; H01C 17/20

(52) U.S. Cl. CPC H05B 3/48; H01C 17/02; H01C 17/20; H01C 17/30; H05B 3/148
USPC 219/534; 29/611; 219/543; 219/553

(57) ABSTRACT

The invention relates to a process for producing a resistance heating element and also to a resistance heating element (10), wherein the resistance heating element has a tubular shape, wherein the resistance heating element is made in one piece, wherein the resistance heating element is produced from silicon carbide, the process comprising the process steps:
formation of a shaped body in one piece from fibers of a fiber material, wherein the fibers have an unstructured fiber orientation,
impregnation of the shaped body with a matrix material,
curing of the matrix material,
pyrolysis of the materials of the shaped body,
siliconization of the shaped body, wherein the shaped body is converted into the resistance heating element.

The invention relates to a process for producing a resistance heating element having the features of Claim 1 and also to a resistance heating element having the features of Claim 17.

Resistance heating elements are routinely used as heating elements for a thermal analysis in so-called DSC furnaces (Dynamic differential calorimetry furnaces). Therefore, the known resistance heating elements are made in the shape of a tube and in one piece and are contacted, on their bottom side, with an anode and a cathode and connecting surfaces, respectively. A wall of the resistance heating element is provided with two grooves, which are made in the shape of a helix, forming heating coils of the resistance heating element. In the area of the heating coils of the resistance heating element, a temperature of up to 1650° C. is reached. Here, a glow pattern is supposed to be distributed across the area of the heating coils as homogeneously as possible. Furthermore, a high degree of purity of the manufacturing material of the resistance heating element is of great significance since, for instance when determining the purity of samples in a DSC furnace, undesirable additives could diffuse out of the resistance heating element and could distort a measurement.

Known resistance heating elements are essentially produced from silicon carbide. Producing a resistance heating element is effected by means of the formation of a material blank from a fiber material, such as carbon fibers, by means stabilization of the shape thereof by means of resin with a concluding pyrolysis as well as by means of an infiltration of silicon, in order to obtain a resistance heating element made of silicon carbide. In particular due to an inhomogeneous distribution of the silicon within the shaped body, it is also possible that cracks emerge. This also causes a reduced stability in the operating state of the resistance heating element since an irregular temperature distribution occurs within the resistance heating element due to the inhomogeneous concentrations of the manufacturing material. It is furthermore known to form a cylindrical shaped body for forming an SiSiC resistance heating element by means of a slurry process. Here, in order to form a desired heating coil structure, a green body formed during a slurry process has to be processed. Here, a low rigidity of the green body substantially limits the processing possibilities, such that heating coils that are comparatively delicate cannot be produced by means of the slurry process. Another disadvantage of the known process is presented by the free silicon of the resistance heating element that is produced with this process since due to the free silicon, which can diffuse out of the resistance heating element, the maximum operating temperature is restricted to approximately 1400° C.

The present invention is therefore based on the task to propose a process for producing a resistance heating element and a resistance heating element, respectively, which avoids the disadvantages known from the state of the art.

This task is solved by a process having the features of claim 1 and by a resistance heating element having the features of claim 17.

With the process according to the invention for producing a resistance heating element, the resistance heating element has a tubular shape, wherein the resistance heating element is made in one piece and wherein the resistance heating element is produced from silicon carbide, wherein the process comprises the following steps:
formation of a shaped body in one piece from fibers of a fiber material, wherein the fibers have an unstructured fiber orientation,
impregnation of the shaped body with a matrix material,
curing of the matrix material,
pyrolysis of the materials of the shaped body,
siliconization of the shaped body, wherein the shaped body is converted into the resistance heating element.

Due to the fact that the shaped body is made in one piece from fibers of a fiber material having an unstructured fiber orientation, accumulations of fibers, which can occur, for instance, when coiling a shaped body, are avoided. A weakening of the manufacturing material such as it occurs with the slurry process, and a corresponding formation of cracks when producing the shaped body and the resistance heating element, respectively, is efficiently precluded in this way. Furthermore, the resistance heating element that is produced in this way essentially does not contain any free silicon, which is why it is particularly well-suited to be used with more than 1400° C.

If the shaped body that is made of fiber material is produced from a felt, the shaped body and the resistance heating element, respectively, can be produced in a particularly cost-efficient and simple way. Thus, coiling the shaped body and the resistance heating element, respectively, in a laborious way or processing a rectangular semi-finished product can be spared since the fiber material has a regularly unstructured fiber orientation across the entire cross-section of the shaped body. In particular, fibers of a felt do not present any specific spatial orientation.

A needle felt can also be used as the felt, which renders the advantage possible that plastic fibers can also be processed into felt. In contrast to natural fibers, with plastic fibers, it is required to form a mechanical cohesion of the unstructured fibers by means of needling.

In a particularly simple embodiment, the shaped body can be made of a plate-shaped fiber material. With the same, a flat and straight resistance heating element can be produced.

The shaped body that is made of fiber material can also be produced from a stacked configuration from fiber material layers. For instance, fiber felt plates, which are only available up to a certain thickness, can be stacked on top of one another and be glued together until a rectangle of fiber felt plate material of a sufficient size has emerged. Subsequently, the rectangle can then be solidified by means of a resin and can be pyrolyzed until a shaped body that essentially consists of a carbon material has emerged.

Furthermore, it is advantageous if the shaped body that is made of fiber material has a round tubular cross-section. In this way, already prior to an impregnation, the shaped body can have the desired shape of the resistance heating element. It is also conceivable that a mechanical processing of the shaped body can then be spared in the further production process. Preferably, a circular tubular cross-section can be formed since a seamless shaped body can simply be formed on a thorn in this case. In principle, the shaped body can, however, have any desired tubular shape. Thus, although the resistance heating element can be produced in a comparatively cost-efficient way by gluing fiber felt plate material together as described above, during the production process, faults in the manufacturing material can occur. In this way, with the following process step, the siliconization, cracks can emerge in the area of the previous glued joints, wherein the cracks cannot be visually detected without further ado. Even if a mechanical processing of the shaped body, which is rectangular then, is effected by means of the formation of a through hole and of a cylinder, cracks in the area of the future heating coil can occur. In this case, the cracks can also be located in the area of the glued joints of the fiber felt plates. Using the shaped body having the round tubular cross-section avoids these disadvantages.

In order to obtain a uniform distribution of silicon carbide and silicon within the resistance heating element, it is advantageous if the shaped body that is made of fiber material has a homogeneous distribution of fibers. In this way, an undesired accumulation of a manufacturing material, such as silicon, between fiber structures that consist of silicon carbide can be avoided. The formation of cracks as a result of inhomogeneities can thus be avoided.

It is particularly advantageous if the fiber material is made of the manufacturing materials polyacrylonitrile, carbon, kynol, viscose, silicon oxide, silicon carbide, aramid or similar fibers or is made of combinations of such fibers. Preferably, a mixture of aramid and polyacrylonitrile fibers (aramid Pan-Ox fiber) can be used. Said fibers can particularly easily be processed to a felt.

It is also advantageous if the matrix material is made of resins composed of the manufacturing materials phenol, epoxide, polyimide, furan, isocyanate, thermoplastics, polyester or vinyl ester or is made of combinations of such resins. Preferably, phenol resins can be used as the matrix material since these can particularly easily be processed.

After the process step of pyrolysis of the materials of the shaped body, a high-temperature treatment of the shaped body can be effected. The pyrolysis can be carried out in a temperature range from 280 to 1200° C. and the high-temperature treatment can be carried out in a temperature range from 1200 to 2400° C. Amongst other things, the high-temperature treatment can serve to free oxygen and nitrogen in the shaped body and can be carried out under vacuum or protective gas. By means of the high-temperature treatment in particular, dimensional deviations of the shaped body that are conditioned by the process steps can be minimized.

Furthermore, it can be envisaged to carry out a mechanical processing of the shaped body prior to or after the pyrolysis. Here, a final shape of the resistance heating element can already be formed by means of the mechanical processing. Thus, for instance with the shaped body having a round tubular cross-section, an internal diameter of the shaped body can be bored up further or can be milled out and a cylinder or an outer diameter can be ground on, for instance, a lathe, such that a uniform wall thickness of the shaped body of, for instance, up to 1 mm is formed. In particular due to a high mechanical stability of the shaped body, the process can thus also make it possible to produce delicate heating coils. Furthermore, helical grooves can be milled into the shaped body that was processed in this way, such that a future heating coil of the resistance heating element is formed. In a base area or between connecting surfaces of the shaped body and of the resistance heating element, respectively, the grooves can be formed as bypassing crosspieces that ensure the stability of the shaped body during the production process. After the resistance heating element has been formed, said crosspieces can simply be cut through and thus be removed.

After or during the siliconization, a desiliconization of the resistance heating element can be effected. In order to obtain a nonporous resistance heating element, the siliconization can be carried out as a capillary siliconization (liquid silicon infiltration). Here, silicon is infiltrated into the carbon material of the shaped body via wicks. Subsequently, the desiliconization causes a removal of excess silicon.

In order to prevent free silicon from escaping during operation of the resistance heating element, a CVD coating process (chemical vapour deposition) of the resistance heating element with silicon carbide can additionally be effected after the desiliconization. With the CVD coating process, a silicon carbide layer is applied onto the resistance heating element, for instance at 700 to 1500° C. The silicon carbide layer covers the resistance heating element essentially completely, such that silicon that might be trapped within the manufacturing material of the resistance heating element cannot escape from the same.

A particularly good contacting of the resistance heating element with connecting contacts can be achieved if, after the desiliconization or after the CVD coating process, connecting surfaces of the resistance heating element are coated by flame spraying. By means of thermal spraying of powdery aluminum, the connecting surfaces can thus be provided with an aluminum layer that can easily be contacted electrically. Aluminum can easily be processed by flame spraying and does not melt off from the resistance heating element during operation of the same.

The impregnation of the shaped body with a matrix material, such as a resin, can be effected in a pressureless manner or by means of vacuum infusion. For instance, the shaped body can be impregnated with a resin by being immersed into a vat containing the same. The impregnation with the resin can also be effected under a vacuum, such that air inclusions that might be present within the shaped body are removed.

Furthermore, it can be advantageous if a compression of the shaped body that has been impregnated is effected prior to the curing of the matrix material. The compression of the shaped body can, for instance, be carried out within an autoclave. In case the shaped body has already been impregnated with resin, for instance, excess resin can be removed by means of a vacuum. It is also possible to regularly compress or press the shaped body that has been impregnated in a mechanical manner by means of a shrink tubing or by means of clamps. The shaped body can also be enveloped by, for instance, a vacuum bag made of a plastic film, wherein, by means of the vacuum, a compression of the shaped body can be effected while a resin is simultaneously supplied for impregnating the shaped body. A curing of the shaped body and of the matrix material or of the resin, respectively, can be carried out by means of a temperature application, at, for instance, 150 to 250° C., of the shaped body that has been compressed and impregnated.

The resistance heating element according to the invention has an essentially arbitrary shape, wherein the resistance heating element is made in one piece, wherein the resistance heating element is produced from silicon carbide, and wherein the resistance heating element has a homogeneous structure or a homogeneous distribution of silicon carbide. In particular the homogeneous structure of silicon carbide within the manufacturing material composition of the resistance heating element causes a minimization of the probability that cracks are formed during the operation of the resistance heating element. Thus, operational safety of the resistance heating element can be substantially advanced. Preferably, the resistance heating element has a tubular shape.

Advantageously, the silicon carbide in the material of the resistance heating element can be structured corresponding to a fiber orientation of a felt. Thus, for producing the resistance heating element, a felt having an unstructured fiber orientation can be used. In this case, the felt can be made such that it is already made in one piece and has a tubular shape.

Further advantageous embodiments of a resistance heating element result from the descriptions of the features contained in the independent claims which relate back to the process claim 1.

In the following, the invention is explained in more detail with reference to the enclosed drawing.

In the drawings:

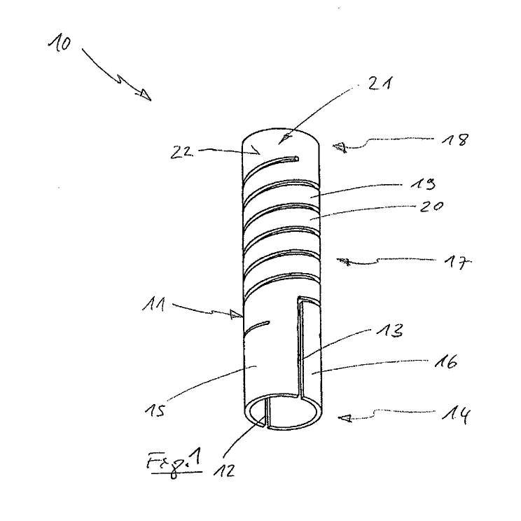

FIG. 1: shows a perspective view of a resistance heating element;

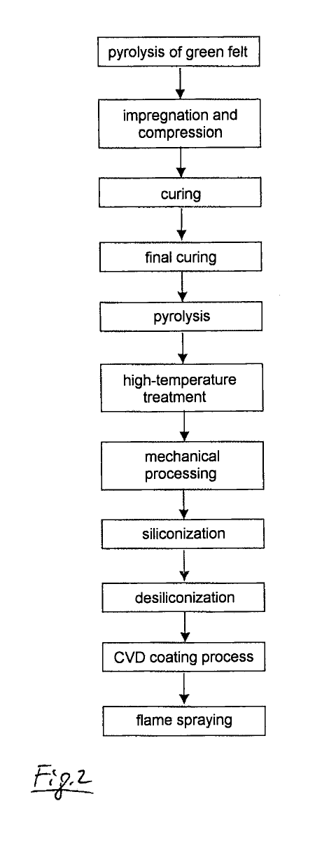

FIG. 2: shows a flow chart for an embodiment of the process.

FIG. 1 shows a resistance heating element 10, which is made in the shape of a tube and with a round annular cross-section. The resistance heating element 10 includes a thin tube wall 11, which is penetrated by two grooves 12 and 13. The grooves 12 and 13 are made in a straight shape in the area of a lower end 14 of the resistance heating element 10 in the longitudinal direction of the same, thus forming two connecting surfaces 15 and 16 for connecting the resistance heating element 10 to connecting contacts of a connecting device, which is not shown here and which belongs to a DSC furnace. In a middle area 17 of the resistance heating element 10, each of the grooves 12 and 13, in the shape of a helix, extends in the longitudinal direction along the circumference of the tube wall 11 to an upper end 18 of the resistance heating element 10. The grooves 12 and 13 thus form two heating coils 19 and 20, which are connected to each other at the upper end 18 in an annular section 21. Heating the resistance heating element 10 during operation is essentially effected in the area of the heating coils 19 and 20. The resistance heating element is made in one piece and essentially consists of silicon carbide, wherein, within the manufacturing material of the resistance heating element 10, residual amounts of silicon, carbon and other manufacturing materials resulting from the production process could be bound. Furthermore, a surface 22 of the resistance heating element 10 is almost completely coated with silicon carbide, wherein, in the area of the connecting surfaces 15 and 16, a layer of aluminum, which is not shown in detail here, is applied.

FIG. 2 shows a possible flow chart of an embodiment of the process. Initially, a pyrolysis of the needle felt and of the shaped body, respectively, is effected and thus, the conversion of the same into a shaped body made of carbon fibers. The shaped body is furthermore impregnated with a phenolic resin and is compressed, wherein a curing of the resin takes place. After a concluding curing of the resin under the effect of temperature, the shaped body is subjected to another pyrolysis for converting the resin into carbon. After a high-temperature treatment for removing any undesired products of the reaction, a mechanical processing of the shaped body is effected, in the course of which the same receives its final shape. In particular due to the fact that the shaped body consists of a carbon material that is structured in a comparatively homogeneous manner, the formation of cracks during the mechanical processing is prevented. Furthermore, a siliconization or infiltration of the shaped body made of carbon with silicon as well as a desiliconization or a removal of excess silicon by means of a gas release follows. Finally, the resistance heating element that has been formed in this way is coated with silicon carbide in the course of a CVD process and connecting surfaces of the resistance heating element are provided with an aluminum layer by flame spraying.

1. A process for producing a one piece resistance heating element produced from silicon carbide, said process comprising:
forming a shaped body in one piece from fibers of a fiber material, wherein the fibers have an unstructured fiber orientation;
impregnating the shaped body with a matrix material;
curing the matrix material;
pyrolysizing of the materials of the shaped body; and
converting the a shaped body into a resistance heating element by siliconizing the shaped body.

2. The process according to claim 1, in which the shaped body that is made of fiber material is produced from a felt.

3. The process according to claim 2, in which the felt is a needle felt.

4. The process according to claim 1, in which the shaped body is made in the shape of a plate.

5. The process according to claim 1, in which the fiber material is a stacked configuration of fiber material layers.

6. The process according to claim 1, in which the shaped body has a round tubular cross-section.

7. The process according to claim 1, in which the shaped body has a homogeneous distribution of fibers.

8. The process according to claim 1, in which the fiber material is selected from a group consisting of polyacrylonitrile, carbon, kynol, viscose, silicon oxide, silicon carbide, and aramid, or of combinations of such fiber material.

9. The process according to claim 1, in which the matrix material is selected from a group consisting of phenol, epoxide, polyimide, furan, isocyanate, thermoplastics, polyester, and vinyl ester, or is made of combinations of such resins.

10. The process according to claim 1, in which after the pyrolysis, a high-temperature treatment of the shaped body is effected.

11. The process according to claim 1, in which prior to or after the pyrolysis, a mechanical processing of the shaped body is effected.

12. The process according to claim 1, in which during or after the siliconization, a desiliconization of the resistance heating element is effected.

13. The process according to claim 12, in which after the desiliconization, a CVD coating process of the resistance heating element with silicon carbide is effected.

14. The process according to claim 12, in which after the desiliconization or after the CVD coating process, connecting surfaces of the resistance heating element are coated by flame spraying.

15. The process according to claim 1, in which the impregnation of the shaped body is effected in a pressureless manner or by means of vacuum infusion.

16. The process according to claim 1, in which a compression of the shaped body that has been impregnated is effected prior to the curing.

17. A resistance heating element comprising:
one piece having a homogeneous distribution of silicon carbide.

18. The resistance heating element according to claim 17, in which the silicon carbide is structured corresponding to a fiber orientation of a felt.

19. The process according to claim 1, in which the formed shape is a tubular shape.
